(19) United States
(12) Patent Application Publication
(10) Pub. No.: US 2026/0017397 A1
(43) Pub. Date: Jan. 15, 2026

(54) OBFUSCATING INFERENCE OPERATIONS OF A MACHINE LEARNING MODEL

(71) Applicant: Google LLC, Mountain View, CA (US)

(72) Inventors: Nahid Farhady Ghalaty, San Diego, CA (US); Matthew Royce Markwell, San Diego, CA (US)

(21) Appl. No.: 18/993,755

(22) PCT Filed: Jul. 14, 2022
(86) PCT No.: PCT/US2022/037149

§ 371 Date: Jan. 13, 2025

(51) Int. Cl. G06F 21/62; G06F 21/32

(52) U.S. Cl. CPC G06F 21/6218; G06F 21/32

(57) ABSTRACT

Methods, systems, and apparatus, including computer programs encoded on computer storage media, for performing inference operations of a machine learning model. One of the methods includes receiving, by a hardware device, data representing a machine learning model comprising a plurality of model parameters for inference operations. The hardware device comprises a set of computation units arranged in one or more processing elements. Instructions are obtained for performing obfuscating operations configured to obfuscate one or more measurable characteristics of the machine learning model, when the machine learning model is executed by the one or more processing elements. A first portion of the set of computation units is caused to perform the inference operations of the machine learning model, and a second portion of the set of computation units is caused to perform the obfuscating operations concurrently with the first portion of the set of computation units performing the inference operations.

### TECHNICAL FIELD

This specification generally relates to a hardware device configured to perform inference operations of a machine learning model. In particular, this specification describes techniques for obfuscating inference operations of a machine learning model compiled on a hardware device.

### BACKGROUND

Artificial intelligence (AI) is intelligence demonstrated by machines and represents the ability of a computer program or a machine to think and learn. One or more computers can be used to perform computations to train machine learning models for respective tasks. Neural networks belong to a sub-field of machine-learning models.

Neural networks can employ one or more layers of nodes representing multiple operations, e.g., vector or matrix operations. One or more computers can be configured to perform the operations or computations of the neural networks to generate an output, e.g., a classification, a prediction, or a segmentation for a received input. Some neural networks include one or more hidden layers in addition to an output layer. The output of each hidden layer is used as input to the next layer in the network, i.e., the next hidden layer or the output layer. Each layer of the network generates an output from a received input in accordance with the current values of a respective set of network parameters.

Hardware accelerators that are particularly designed can perform specific functions and operations, including operations or computations specified in a neural network, faster and more efficiently when compared to operations run by general-purpose central processing units (CPUs). The hardware accelerators can include graphic processing units (GPUs), tensor processing units (TPUs), video processing units (VPUs), field programmable gate arrays (FPGAs), or application-specific integrated circuits (ASICs).

### SUMMARY

A machine learning model (e.g., a neural network), after being properly trained, can be compiled and deployed on a hardware device configured to perform inference operations for processing input data. The inference operations are defined by parameters of the neural network that are updated during the training process. The parameters define (i) nodal operations (e.g., linear and nonlinear operations) for nodes in each network layer of a neural network and (ii) the structure of the neural network. For example, the parameters defining the nodal operations include parameters defining activation functions for each network layer and parameters defining nodal weights for nodes in a network layer. As another example, the parameters defining the structure (also referred to as hyperparameters) include at least one of the number of nodes in a network layer, the number of network layers in a machine learning model (e.g., in a neural network), or the nodal connections across neighboring layers (e.g., fully connected layers, convolution layers, or transposed convolution layers). For simplicity, the following specification is described for a neural network but can apply to other types of machine learning models.

Keeping parameters of a trained neural network confidential is critical. First of all, training a neural network, in particular, a deep neural network with satisfactory accuracy for generating predictions requires considerable computation cost and time. In addition, some neural networks have applications related to security-sensitive authentication, such as face unlock tasks where a neural network is configured to recognize faces for conveniently unlocking devices. It is therefore critical to maintain the structure and parameters of the neural network undecipherable or at least difficult to decipher to avoid malicious actors learning the parameters and using those parameters for unauthorized device unlocks.

However, different techniques can be applied to “decode” a trained neural network, particularly when the neural network is implemented on a hardware device that is accessible by a third party (e.g., an edge device such as a smartphone, a smartwatch, a smart tablet, or other edge devices). For example, one technique can measure characteristics of a trained neural network when a hardware device performs inference operations of the trained neural network. More specifically, the technique can collect data, e.g., power consumption, electromagnetic waves, or time, when a hardware device performs inference operations, and determine neural network parameters and structure by analyzing characteristic profiles generated based on the collected data. This technique is also referred to as side channel attacks.

The techniques described in this specification can enhance the security for neural networks implemented on hardware devices, e.g., on edge hardware devices. For example, the described techniques defend against side channel attacks by using a special hardware device, which is configured to perform obfuscating operations and inference operations of a deployed neural network concurrently. In this way, the described techniques can prevent side channel attacks or at least raise the bar of the computation and/or time cost for deciphering the deployed neural network using side channel attacks.

The term “obfuscating operations” used throughout the specification generally refer to operations that, when performed concurrently with machine learning operations (e.g., inference operations) of a deployed neural network by a hardware device, cause a change in one or more measurable characteristics of the neural network, so that at least one parameter of a neural network, e.g., at least one of a number of network layers of the neural network, a number of nodes in a network layer, a nodal operation for a node in a network layer, or a weight associated with a node in a network layer, is obscured. Note that different types of machine learning models include different types of parameters that define the models. The techniques described in this document can obfuscate any type of parameter that impacts the measurable characteristics of the machine learning model.

The one or more measurable characteristics of the neural network generally refer to measurable data when the hardware device performs inference operations in the neural network. The measurable data can include data or a profile related to the power consumption, time, electromagnetic emanations, or other measurable data, as described above.

The term “concurrently” used throughout this specification generally refers to a common time period when both obfuscating operations and inference operations are performed by a hardware device. For example, the common time period can be an exactly same time period, a substantially the same time period (e.g., within a threshold period of time of each other), or two different time periods having an overlapping region.

Examples of obfuscating operations can be operations performed concurrently with nodal operations in a neural network can include suitable types of linear or nonlinear operations different from actual operations in a neural network. In some implementations, obfuscating operations can sometimes mimic the actual operations. For example, obfuscating operations performed concurrently with a nodal linear operation of a particular node can also be linear operations such as additions, multiplication, and binary operation. As another example, an obfuscating operation performed concurrently with a nodal non-linear operation of a particular node can also be nonlinear operations such as activation functions, e.g., ReLU, Sigmoid, Tanh, or other suitable nonlinear operations. As another example, obfuscating operations can include tensor reduction operations that mimic action-weight multiplications of a network layer. Additional examples of obfuscating operations are described below.

In general, the special hardware device receives instruction data from a host or other device. The instruction data includes a compiled machine learning model with multiple model parameters for inference operations. The instruction data can include a set of instructions to instruct a hardware device (e.g., one or more processors of a hardware device) to perform inference operations with the compiled machine learning model. The set of instructions generally include inference operations specified by the machine learning model and respective instructions for corresponding computation components in the hardware device to perform at least a portion of the inference operations. In some situations, the instructions can further include at least one instruction for the hardware device to perform obfuscating operations concurrently with the inference operations. Note that the received instructions may not include obfuscating operations and the scheduling of the obfuscating operations. In this example, the hardware device can generate the obfuscating operations and a corresponding schedule for performing the obfuscating operations over computation units in the hardware device in response to receiving the set of instructions from the host.

The hardware device can include one or more processing elements configured to process portions of the inference operations. Each of the processing elements includes multiple computation units specially arranged to perform machine learning computations, e.g., in ways that accelerate the performance of the machine learning operations. The details of the arrangements of computation units are described in greater details below.

The hardware device can determine new instructions that, based on the received instructions, when executed by the hardware device, cause one or more processing elements to perform inference operations of the machine learning model and obfuscating operations concurrently. For example, the hardware device can be configured to determine the instructions by (i) modifying the received instructions from a host or (ii) generating additional instructions to be incorporated with the received instructions.

The hardware device can include a managing component, such as an on-chip scheduler, a controller, a core manager, or other suitable managing component, that is configured to determine the instructions. The determined instructions can include instructions that, when executed by one or more processing elements, cause a first portion of a set of computation units to perform the inference operations of a neural network. In addition, the determined instructions can include instructions that, when executed by the one or more processing elements, cause a second portion of the set of computation units to perform obfuscating operations concurrently with the performance of the inference operations.

In situations where the managing component is configured to modify the received instructions from a host, the instructions generated by the host include schedule data assigning different portions of inference operations to different processing elements. The managing component generally reassigns the inference operations and obfuscating operations to different computation units. For example, for a processing element with 16 computation units that are assigned to perform a first portion of inference operations indicated by the received instructions from the server, the managing component modifies the received instructions and for example, assigns one or more of the 16 computation units to perform obfuscating operations, and reassign the corresponding inference operations to different computation units, for example, that are located in one or more different processing elements. As another example, the processing element can modify the received instructions to instruct other components (e.g., dedicated processing elements) different from the processing units to perform obfuscating operations.

In situations where the managing component is configured to generate new instructions to be incorporated with the received instructions from a host. The received instructions do not include schedule data regarding the inference operation assignment. Rather, the managing component is configured to generate new instructions that, for example, indicate a first portion of computation units in processing elements to perform inference operations of a neural network, and a second portion, different from the first portion, of computation units in processing elements to perform obfuscating operations. In some implementations, the new instructions indicate processing elements to perform corresponding inference operations, and other components different from the processing elements to perform obfuscating operations. The details of modifying instructions are described below.

The subject matter described in this specification can be implemented in particular embodiments so as to realize one or more of the following advantages. Using a special hardware device for concurrently performing obfuscating operations and inference operations can efficiently prevent parameters of a deployed neural network in the hardware device from being deciphered. More specifically, the obfuscating operations can cause a change in one or more measurable characteristics of a neural network executed by the hardware device, so that it becomes difficult and costs more time and resources to decipher corresponding neural network parameters based on measurable characteristics. Thus, the described techniques enhance data security by preventing the leakage of potentially sensitive machine learning data.

The subject matter described in this specification is further advantageous from the model compilation perspective. For example, the described techniques do not change existing compiling operations. A system or a host does not need to modify the existing neural network and/or recompile a previously-compiled neural network. Rather, the previously compiled neural network (e.g., a machine readable binary profile) and corresponding instructions can be directly provided to the hardware device. To schedule and perform obfuscating operations on the special hardware device, the hardware device can, at the run time, adjust the instructions for coordinating components in the hardware device to perform inference operations and obfuscating operations concurrently. In this way, the described techniques save considerable research and development time for updating and compiling a neural network model. This also prevents errors in the machine learning model that may be introduced in the development process to include obfuscating operations.

Other implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation causes the system to perform the actions. One or more computer programs can be so configured by virtue of having instructions that, when executed by data processing apparatus, cause the apparatus to perform the actions.

The details of one or more implementations of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIG. 1 is a block diagram of an example system including a hardware device.

FIG. 2 illustrates an example processing element in a hardware device.

FIG. 3 illustrates an example assignment of computation units for concurrently performing inference operations and obfuscating operations.

FIG. 4 illustrates another example assignment of computation units for concurrently performing inference operations and obfuscating operations.

FIG. 5 illustrates another example assignment of computation units for concurrently performing inference operations and obfuscating operations.

FIG. 6 is an example flow chart of process for obfuscating inference operations of a machine learning model.

Like reference numbers and designations in the various drawings indicate like elements.

### DETAILED DESCRIPTION

The subject matter described in this specification relates to a special hardware device having multiple computing units configured to accelerate machine learning operations, e.g., inference operations) for a machine learning model and obfuscate the inference operations by concurrently performing obfuscating operations when performing the inference operations. The described hardware device can be a hardware processor, e.g., a hardware accelerator, deployed on an edge device, e.g., a smartphones, smart tablets, smart watches, or other suitable edge devices. The hardware device can include one or more processing elements, and each processing element can include one or more computation units. The hardware device can schedule obfuscating operations and inference operations to be performed by different processing elements in the hardware device or different portions of computation units in each processing element. Each computing unit of the hardware computing system is self-contained and can independently execute at least a portion of computations required by a given layer of a multi-layer neural network.

One example machine learning model can be a neural network, which is trained to perform inference tasks. A trained neural network includes multiple parameters defining the neural network and inference operations in the neural network. The parameters of a neural network can include a number of network layers in the neural network, a number of nodes in the neural network, a nodal operation for each node, and/or a nodal weight of each node. The neural network computes an inference for processing an input by performing inference operations of a neural network. In particular, the layers of the neural network each have multiple nodes with respective nodal operations and weights. The nodal operations can include linear operations (e.g., multiplications and additions) or non-linear operations (e.g., activation operations including the ReLu activation function, the Tanh function, and the Sigmoid function). In some implementations, the parameters further include data determining nodal connections between neighboring network layers, e.g., fully connected layers, convolution layers, or transpose convolution layers.

The hardware device can perform inference computation of a neural network by distributing or assigning different portions of inference operations across multiple computation units. One example of computation units is tiles each having a computation unit or a processing engine, and/or one more caches and switches. An example computation process performed for a neural network layer can include a multiplication of an input tensor including input activations with a parameter tensor including weights. This computation includes multiplying an input activation with a weight on one or more cycles and performing an accumulation of a product over many cycles. The computation results for the network layer can be written to an output bus and stored in memory.

When performing inference operations of a deployed neural network, a hardware device generates one or more measurable characteristics of the neural network. Different techniques such as side channel attacks can be used to reverse engineer parameters of the trained neural network. In some situations where the hardware device is included in an edge device such as a smartphone, a smart watch, a smart tablet, or other suitable edge devices, one can repeatedly perform test operations using the hardware device and determine parameters of the neural network.

It is desired to maintain neural network parameters confidential for different reasons. One example is from the security point of view. A neural network can be configured to perform human face recognition tasks for conveniently unlocking devices. It would be unsafe to use the face unlocking mechanism if a third party successfully reverse-engineered the neural network and figured out a way to deceive the face unlocking mechanism. For example, a malicious actor might use adversarial attacks to deceive the neural network to unlock devices for which the actor does not have authorization.

The described techniques can solve the above noted security concern by obfuscating inference operations of a neural network. More specifically, the hardware device is configured to issue instructions that, when executed by the hardware device, cause different components in the hardware device to perform inference operations in a neural network and obfuscating operations concurrently. By concurrently performing obfuscating operations, the hardware device can change at least one of multiple measurable characteristics of the neural network. In this way, the hardware can efficiently hide or mask the measurable characteristics of the actual machine learning operations being performed by the hardware device, and make the deciphering process impossible, impractical, or at last much more difficult by analyzing the masked or changed measurable characteristics. The details of performing obfuscating operations are described below.

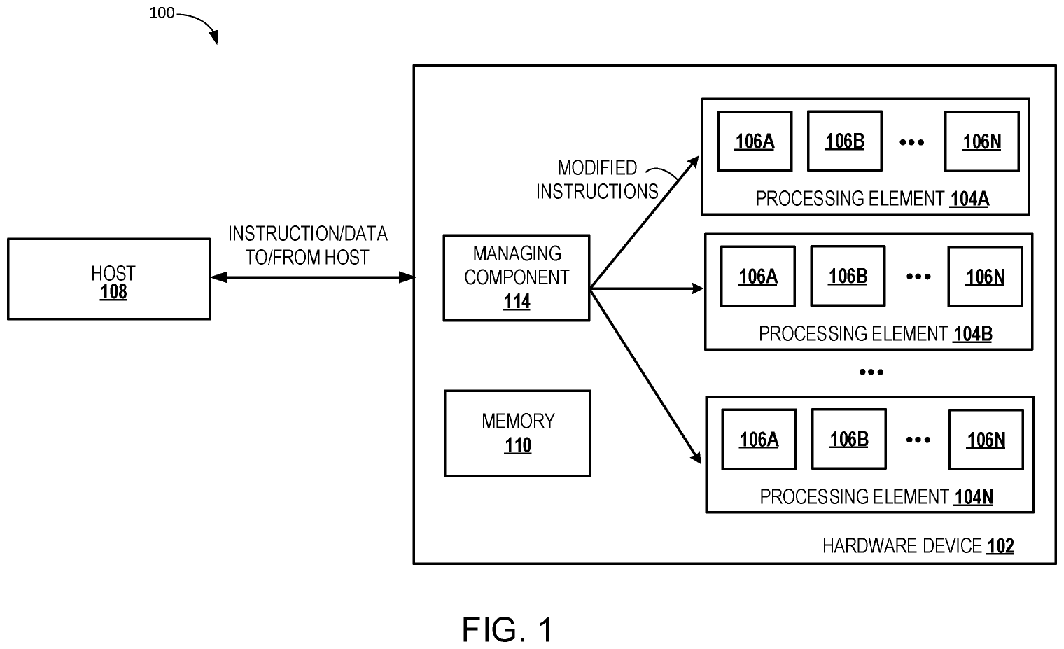

FIG. 1 is a block diagram of an example system 100 including a hardware device 102. The hardware device 102 is communicatively coupled with a host 108, e.g., via one or more networks. In general, the hardware device 102 is configured to receive instructions or data from the host 108 and provide data back to the host 108. In general, a host is configured to compile a trained machine learning model into a machine-readable program (e.g., binary code). The binary code generally includes all parameters that define the trained machine learning model. The binary code, for example, specifies a number of network layers in the compiled neural network, a type of each network layer, a number of nodes in each network layer, a nodal operation for each node in each network layer, a nodal weight determined for each node in each network layer, and inter-layer connectivity. The binary code can include any other parameters of a machine learning model.

The host 108 also generates instructions that, when executed by the hardware device 102, cause the hardware device 102 to perform inference operations specified by the binary code. In some implementations, the host 108 can generate a schedule for performing the inference operations, e.g., data indicating the assignment of inference operations to different computation components in the hardware device 102 and a sequence for performing the inference operations. In general, the instructions generated by the host 102 may not include specific obfuscating operations to obfuscate parameters of a machine learning model. Instead, the obfuscating operations are determined, scheduled, and performed by the hardware device 102, and it is the hardware device that modifies the received instructions from the host 108 or generates new instructions including obfuscating operations to be performed concurrently with inference operations.

In some implementations, the instruction data generated by the host 108 and sent to the hardware device 102 can include a set of instructions that includes at least one instruction for the hardware device to perform obfuscating operations concurrently with the inference operations. For example, the at least one instruction can instruct the hardware device to perform inference operations of the machine learning model in a “secured mode,” where the hardware device performs one or more obfuscating operations concurrently with inference operations performed by the hardware device. As another example, after receiving the at least one instruction, the hardware device can be notified that one or more applications using a machine learning model deployed on the hardware device might request the inference operations of the machine learning model to be performed in the secured mode. The hardware device 102 can determine specific obfuscating operations upon receiving the applications' requests.

In some implementations, the instruction data generate by the host 108 and sent to the hardware device 102 can include the machine learning model without an instruction to perform obfuscating operations. In this example, the hardware device 102 can determine whether to perform obfuscating operations concurrently with the inference operations as described herein.

After performing inference operations specified by the received instructions from the host 108, the hardware device 102 can provide data such as computation results to the host 108. The computation results can include at least a portion of layer outputs in a network layer, or layer outputs for two or more network layers.

A hardware device can be a hardware processor, e.g., a hardware accelerator such as a graphics processing unit (GPU), a vision processing unit (VPU), a tensor processing unit (TPU), or other appropriate hardware accelerator. To accelerate performing inference operations, the hardware device 102 includes one or more processing elements 104A-N, and each processing element 104A-N includes one or more computation units 106A-N, which are also referred to as computation units 106 for brevity. The computation units 106 are each a self-contained unit for performing assigned inference operations (e.g., linear or nonlinear operations for a node in a network layer or across network layers). The number of processing elements 104A-N and corresponding computation units for each processing element can vary based on different computation requirements. For example, the hardware device 102 can include 4, 8, 16 or more processing elements each having 4, 8, 16, or more computation units. In addition, different hardware devices 102 can have different arrangements and interconnections for processing elements 104A-N.

After receiving the instructions and/or data from the host 108, the hardware device 102 can store data representing parameters of the assigned inference operations in the neural network in the memory 110. The details of memory 110 are described below. The parameters can include a number of nodes and a number of network layers assigned to the hardware device 102, nodal weights, and corresponding input activations from a previous network layer. In some implementations, the hardware device 102 can store the instructions in the memory 110.

The managing component 114 is configured to determine whether to perform inference operations in a “standard mode” or a “secured mode.” The managing component 114 can determine different modes to perform operations based on the nature or application of a neural network. In other words, the managing component 114 can select, for a machine learning model, to either perform the operations of the machine learning mode using the secured mode or the regular mode. For example, the managing component 114 can determine to perform operations under the secured mode if the neural network is a giant deep neural network that requires considerable time and costs (e.g., computation costs to train) and the hardware device 102 is located inside an edge device. In this example, the managing component 114 can select the mode based on the size (e.g., by comparing the size of the model to a threshold) and/or based on training time (e.g., by comparing the time taken to train the model to a threshold, and such information can be included in, e.g., metadata transmitted to the managing component 114). As another example, the managing component 114 can determine to perform operations of a neural network under the secured mode if the neural network is used for security-sensitive applications, for example, face unlocking, voice unlocking, signature verification, personal information access or predictions using machine learning models, or other security-sensitive applications. In this example, applications using security-sensitive machine learning models can request the hardware device to operate in the secured mode when performing operations of these machine learning models. In some implementations, the request sent to the management component 114 can include a label or metadata that indicates whether the machine learning model is sensitive or that indicates which mode (e.g., secured or regular) that is to be used to perform the operations of the machine learning model. The managing component 114, on the other hand, can include an application programming interface (API) configured to receive the request and determine the mode (e.g., secured or regular) for performing operations of one or more machine learning models.

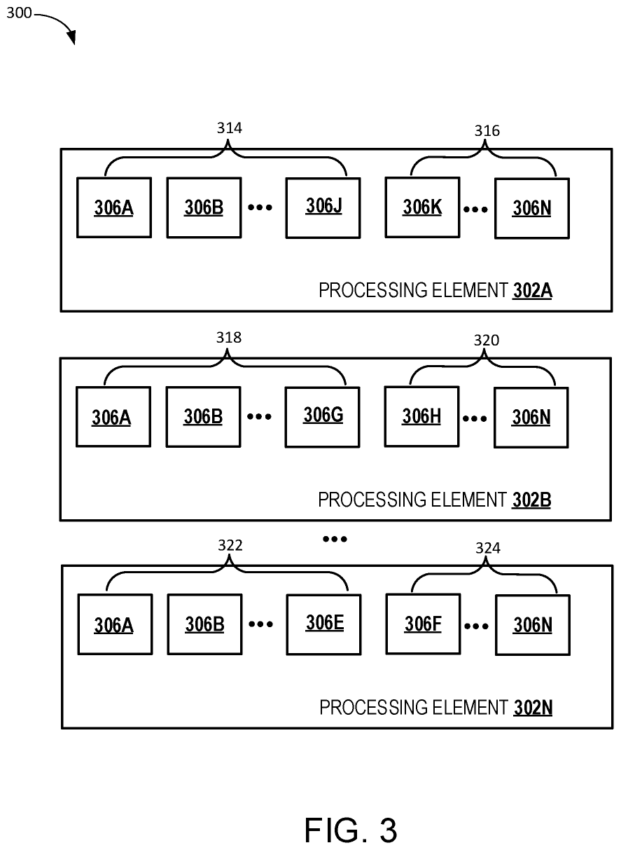

The term “standard mode” used throughout the specification generally refers to a mode in which the hardware device 102 does not perform obfuscating operations to hide or mask measurable characteristics of the assigned portion of the neural network. The term “secured mode” used throughout the specification generally refers to a mode in which the hardware device 102 performs obfuscating operations to hide or mask measurable characteristics of the assigned portion of the neural network. The examples of obfuscating operations are described in connection with FIG. 3.

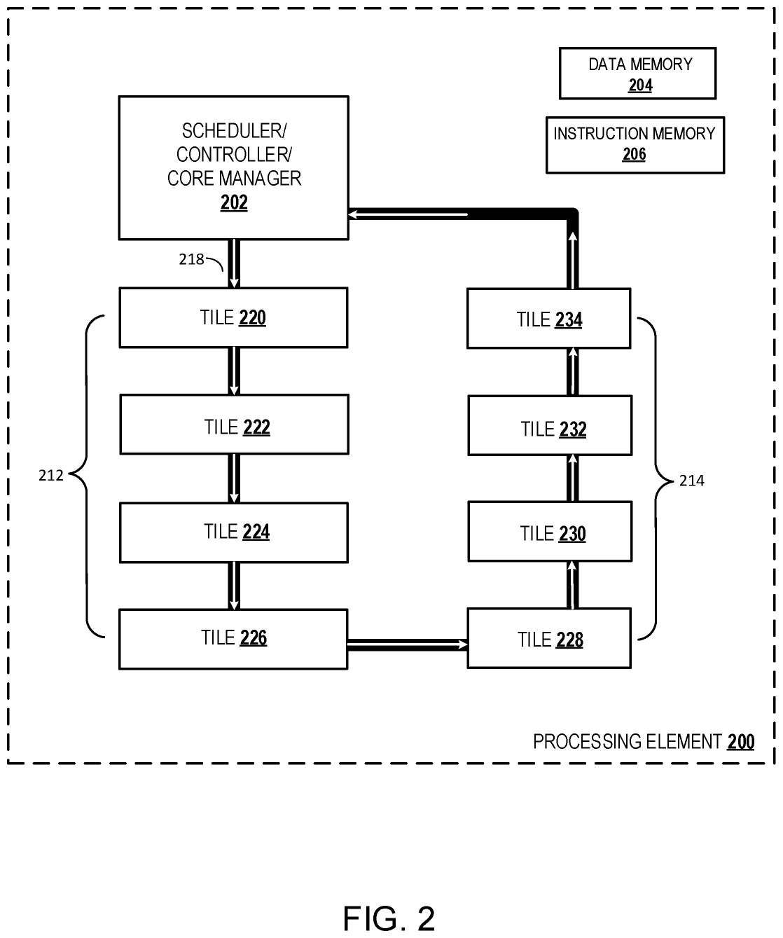

If the managing component 114 determines to perform inference operations under the standard mode, the managing component 114 can broadcast the received instructions (e.g., without any modifications to the received instructions) to different processing elements 104A. The instructions and parameters for inference operations are broadcast to each computation unit 106 in each processing element 104A along a data bus. The details of transmitting instructions and data across different computation units 106A-N in a processing element 104A-N are described in connection with FIG. 2. In general, all available computation units 106 in a processing element 104 typically perform a respective portion of inference operations to maximize the computation power of a processing element and the speed at which the operations are performed. However, in some implementations, the instructions or schedule from the host 108 (or from the managing component 114) can specify a portion (e.g., one or more) of computation units 106 in one or more processing elements 104 to perform the inference operations.

If the managing component 114 determines to perform inference operations under the “secured mode,” the managing component 114 can modify the received instructions to generate modified instructions that, when executed by the hardware device 102, cause one or more computation units in the hardware device 102 to perform obfuscating operations. To modify the received instructions, the managing component 114 can first determine if there exists a schedule in the received instructions from the host 108.

In response to determining that a schedule does not exist, the managing component 114 can generate a schedule specifying a first portion of computation units 106 of the processing elements 104 to perform the assigned inference operations, and a second portion of the computation units 106 of the processing elements 104 to perform obfuscating operations. In some implementations, the schedule generated by the managing component 114 can specify other computation components that are different from the computation units to perform obfuscating operations. The other computation components can be multiplexers, logic units, adders, multiplication units, or other computation components.

In response to determining there is an existing schedule in the received instructions, the managing component 114 can modify the schedule by reassigning one or more computation units 106, originally scheduled to perform corresponding inference operations according to the received instructions, to perform obfuscating operations, and reassign the corresponding inference operations to be performed by other computation units 106 in one or more other processing elements 104. In some implementations, a processing element or a computation unit of a processing element can be an additional element added to the hardware device or to the edge device that includes the hardware device and is dedicated to performing the obfuscating operations. The term “dedicated” generally refers to one or more processing elements or computation units that are additionally incorporated into a hardware device (e.g., in addition to other elements or units in a hardware device for performing inference operations) and are configured to perform substantially only obfuscating operations and do not perform inference operations associated with deployed machine learning models. The processing elements or computation units dedicatedly for performing obfuscating operations can include, e.g., a processor, a multiplication unit, a multiplexer, a vector reduction unit, a logic gate, or other suitable processing elements or computation units.

The modified instructions are broadcast to corresponding processing elements 104A-N by the managing component 114. The modified instructions can cause, when executed by corresponding computation units 106A-N in the processing elements 104A-N, a first portion of computation units to perform inference operations and a second portion of computation units to perform obfuscating operations concurrently with the first portion of the set of computation units performing the inference operations.

The obfuscating operations in general can be any operations that could hide or mask measurable characteristics of a neural network. In other words, the obfuscating operations can include operations that cause the hardware device 102 and/or the edge device that includes the hardware device 102 to generate or adjust one or more measurable characteristics.

The measurable characteristics include an electromagnetic profile for one or more inference operations, a time profile for performing the one or more inference operations, or power consumption profile for computation units performing the inference operations. In some implementations, the measurable characteristics can include a sound profile and/or a temperature profile for performing the one or more inference operations. An electromagnetic profile can, for example, represent a measure of electromagnetic radiation over a capacitor charge on a hardware device when the hardware device is preforming operations of a machine learning model. In some implementations, a characteristic profile can be represented by a graph having a horizontal axis representing time and a vertical axis representing a particular characteristic (e.g., the electromagnetic radiation, the power consumption, the sound, or the temperature). Other representations of the changes in these characteristics over time during the execution of a machine learning model can also be used to represent the profiles, e.g., in the form of tables, vectors, etc.

In some implementations, the obfuscating operations can mimic the corresponding inference operations concurrently performed during a time period. As an example, when one or more assigned computation units are calculating output activations of the machine learning model using nodal activation functions, the modified instructions can instruct one or more other computation units to concurrently perform different obfuscating activation functions to obfuscate the measurable characteristics of the computation units calculating the output activations of the machine learning model. Both inference operations and obfuscating operations are related to different activation functions, so that the combined data profiles (e.g., power consumption profile) is different from that for performing only the inference operations. Therefore, the measurable characteristics deviates from the true measurable characteristics of the neural network, and any reverse-engineered neural network parameters could be different from the true neural network parameters.

In some implementations, the obfuscating operations can be irrelevant to (e.g., independent of) the corresponding inference operations concurrently performed during a time period, but performing the obfuscating operations can render any measurable data from the hardware device 102 meaningless. For example, when the inference operations are related to matrix reductions, the obfuscating operations can be particular logic operations or scalar additions or multiplications such that the true measurable profiles are altered to lose patterns or features, which become meaningless for determining the true parameters of a neural network.

The computation results of inference operations are stored in memory 110, and are provided to the host 108 for other inference operations that depend on the computation results. The computation results for obfuscating operations, however, are not used by any of the inference operations. In some implementations, obfuscating results are discarded without writing to any memory. Alternatively, obfuscating results are written to a memory unit that other computation components for inference operations do not receive any data stored in the memory unit.

FIG. 2 illustrates an example processing element 200 in a hardware device. The processing element 200 is configured to process at least a portion of inference operations of a compiled neural network.

As shown in FIG. 2, the processing element 200 generally includes a managing component 202 (e.g., a controller/scheduler/core manager) and multiple tiles 220-234 including a first tile set 212 and a second tile set 214. The managing component 202 is configured to execute instructions received from a host, and optionally modify the received instructions to be executed. The managing component 202 can be equivalent to the managing component 114 of FIG. 1. The managing component 202 can be a master managing component that determines instructions for all computation components located on the hardware device, as shown in FIG. 1. Alternatively or in addition, each processing element (e.g., processing element 200) can have a respective controller configured to determine instructions for scheduling operations to be performed in the processing element. For simplicity, the managing component 202 is also referred to as a controller 202 in the following description.

The multiple tiles 220-234 are communicatively coupled with one and another by a data bus 218 according to a sequence. The data bus 218 includes different types of data buses for communicating respective instructions indicating different operations performed on different tiles, input data used for performing operations on different tiles, and results for the input data generated on different tiles. For example, the data bus 218 can include a ring bus that starts from the controller 202, and provides communications coupling through a bus data path that connects tiles 112, 114 sequentially in a ring back to the controller 102. In some implementations, the data bus 218 can include a mesh bus that provides a communications path that couples or connects each tile to its corresponding neighbor tile in both horizontal and vertical dimensions. The mesh bus can be used to transport input activation quantities between one or more memory units in adjacent tiles.

In general, a tile 220, 222, 224, 226, 228, 230, 232, or 234 is a core component within the processing element 200 and is the focal point for performing inference computations. Each tile is a self-contained computational component for performing assigned inference operations. One or more of these tiles in the processing element 200 perform inference operations assigned to the processing element 200 according to the received instructions. For example, to maximize utilizing the computation units in the processing element, each tile cooperates with the other tiles in the processing element 200 to accelerate computations across one or more layers of a multi-layer neural network. Although the processing element 200 as shown in FIG. 2 has eight computation units (e.g., tiles 220, 222, 224, 226, 228, 230, 232, 234) coupled with one another by the data bus 218 for ease of illustration, the processing element 200 can include a different number of computation units coupled with one another, e.g., 4, 16, 32, or other suitable numbers.

The controller 202 is configured to modify the received instructions or add new instructions to be incorporated with the received instructions, so that when the modified instructions are executed by the processing element 200, one or more computing units (e.g., tiles) in some processing elements perform obfuscating operations and one or more other computing units perform inference operations in the neural network. For example, tile 220, 224 in the first tile set 212 might be instructed by the controller 202 to perform obfuscating operations and the other tiles 222, 226, 228, 230, 232, and 234 are instructed by the controller 202 to perform inference operations of the neural network. Assigning computation components (e.g., tiles or other components) to perform obfuscating operations are described in greater detail in connection with FIGS. 3-5.

In some implementations, instructions generated by a host include a schedule for performing inference operations using different component units (e.g., different tiles). For example, the received instructions can include a set of non-overlapped portions of inference operations and a set of processing units and corresponding computation units assigned for performing corresponding non-overlapped portions. In these situations, the controller 202 can determine one or more tiles in a particular processing element that are originally assigned by the received instructions to perform corresponding inference operations to perform obfuscating operations. The controller 220 can further determine other idle tiles in one or more processing elements different from the particular processing element to perform the corresponding inference operations originally assigned to the one or more tiles. For example, the controller reassigns tiles 228-234 to perform obfuscating operations, and assign idle tiles in other processing elements to perform the corresponding inference operations that are originally assigned to tiles 228-234. Alternatively, the controller 202 does not reassign tiles that are originally assigned by the received instructions for performing inference operations to perform obfuscating operations. Rather, the controller 2020 determines idle computation components such as idle processing elements, multiplication units, logic units, or other suitable units to perform obfuscating operations. For example, the tiles 220-234 keep performing inference operations, and the hardware device instructs other computation components to perform obfuscating operations.

In some implementations, instructions generated by a host do not include scheduling information, e.g., which computation units perform what inference operations and when. In these situations, the controller 202 can generate new instructions for scheduling tiles to perform corresponding operations. The controller 202 can incorporate the new instructions with instructions received from the host and issue the instructions along the data bus 218 to different tiles. For example and as described above, the modified instructions, when executed, can reassign a first portion of tiles to perform obfuscating operations and determine other idle tiles to perform corresponding inference operations that are originally assigned to the first portion of tiles. Alternatively or in addition, the modified instructions, when executed, can cause tiles to maintain performing assigned inference operations, and cause other idle computation components (e.g., adders, multiplication units, logic units, or other processing elements) to perform obfuscating operations.

The processing element 200 further includes one or more memory units. For example, the memory units can include data memory 204 and instruction memory 206, as shown in FIG. 2. Instruction memory 206 may store one or more machine readable instructions that are executable by the one or more processors of controller 202. Data memory 204 may be any of a variety of data storage mediums for storing and subsequently accessing a variety of data relating to computations that occur within system processing element 200, e.g., parameters of the neural network for performing the assigned inference operations, and one or more computation results for processing a particular input. In some implementations, data memory 204 and instruction memory 206 are volatile memory unit or units. In some other implementations, data memory 204 and instruction memory 206 are non-volatile memory unit or units. Data memory 204 and instruction memory 206 may also be another form of computer-readable medium, such as a floppy disk device, a hard disk device, an optical disk device, or a tape device, a flash memory or other similar solid state memory device, or an array of devices, including devices in a storage area network or other configurations.

FIG. 3 illustrates an example assignment 300 of computation units for concurrently performing inference operations and obfuscating operations. The assignment 300 can be determined by one or more computers located at one or more different locations. For simplicity, the assignment 300 can be determined by a managing component, e.g., managing component 114 of FIG. 1, when properly programmed, can generate instructions to determine the assignment 300.

As shown in FIG. 3, the modified instructions, when executed by a hardware device (e.g., the hardware device 102 shown in FIG. 1), can cause a first portion of computation units (e.g., tiles 220-234 shown in FIG. 2) in a processing element to perform inference operations and a second portion of computation units in the processing element to perform obfuscating operations concurrently with the performance of inference operations.

One example assignment 300 indicates a first portion 314 of computation units 306A-J in the processing element 302A are instructed to perform corresponding inference operations, and a second portion 316 of computations 306K-306N in the processing element 302A are instructed to perform obfuscating operations concurrently with the inference operations performed by the first portion 314 of computation unit 306A-J. In some implementations, the assignment can indicate one or more processing elements 302A-302N and different portions of computation units 306A-306N in each of the one or more processing elements 302A-302N to perform obfuscating operations. For example, a first portion 318 of computation units 306A-306G are instructed to perform corresponding inference operations, a second portion 320 of computation units 306H-306N are instructed to perform obfuscating operations concurrently, a first portion 322 of computation units 306A-306E are instructed to perform corresponding inference operations, and a second portion 324 of computations 306F-306N are instructed to perform obfuscating operations concurrently. The number of computation units for performing obfuscating operations and the number of computation units for performing inference operations can vary across different processing elements 302A-302N. The instructions can further reassign corresponding inference operations from portions of computation units, that are instructed to perform obfuscating operations, to other idle computation units in other processing elements.

Note the number of processing elements 302A-N, the number of computation units 306A-N in each processing element 302A-N, and the number of computation units 306A-N in each portion are illustrative in FIG. 3. One should appreciate that these numbers and/or arrangements of computation units and processing elements can vary based on different obfuscating requirements. For example, any number of computation units of any number of processing elements can be assigned to perform obfuscating operations.

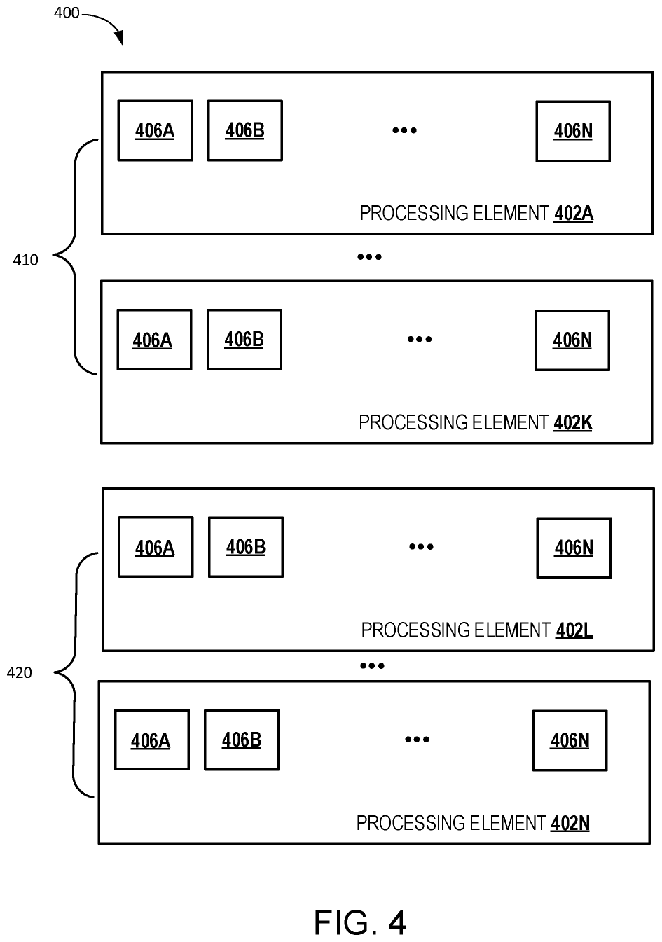

FIG. 4 illustrates another example assignment 400 of computation units for concurrently performing inference operations and obfuscating operations. The assignment 400 can be determined by one or more computers located at one or more different locations. For simplicity, the assignment 400 can be determined by a managing component, e.g., managing component 114 of FIG. 1, when properly programmed, can generate instructions to determine the assignment 400.

As shown in FIG. 4, the modified instructions, when executed by a hardware device (e.g., the hardware device 102 shown in FIG. 1), can cause a first portion 410 of processing elements 402A-K to perform inference operations and a second portion of processing elements 402L-N to perform obfuscating operations concurrently with the performance of inference operations. In this situation, one or more computation elements 406A-N in the first portion 410 of processing elements 402A-K perform inference operations, and no computation elements in the first portion perform obfuscating operations. In situations where the received instructions from the host includes a schedule for assigning inference operations to computation units, these computation units in the first portion would continue to perform the assigned inference operations. The managing component determines computation units in other processing elements (e.g., the second portion 420) that are different from the first portion to perform obfuscating operations.

The example assignment 400 can be combined with the example assignment 300 for instructing computation units to perform respective operations. For example, the instructions can cause one or more first processing units to perform obfuscating operations, and one or more second processing units different from one first processing units to perform both obfuscating operations and inference operations. For example, a first portion of computation units of the one or more second processing units are instructed to perform corresponding inference operations, and a second portion of computation units of the one or more second processing units are instructed to perform corresponding obfuscating operations.

Again, note the number of processing elements 402A-N, the number of computation units 406A-N in each processing element 402A-N, and the number of computation units 406A-N in each portion are illustrative in FIG. 4. One should appreciate that these numbers and/or arrangements of computation units and processing elements can vary based on different obfuscating requirements.

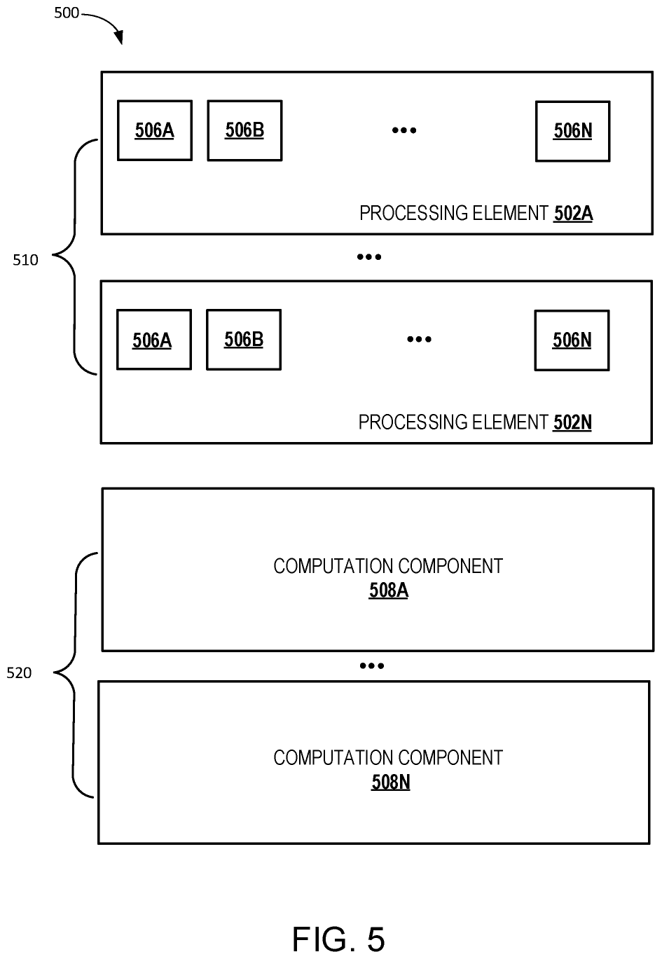

FIG. 5 illustrates another example assignment 500 of computation units for concurrently performing inference operations and obfuscating operations. The assignment 500 can be determined by one or more computers located at one or more different locations. For simplicity, the assignment 500 can be determined by a managing component, e.g., managing component 114 of FIG. 1, when properly programmed, can generate instructions to determine the assignment 500.

As shown in FIG. 5, the modified instructions, when executed by a hardware device (e.g., the hardware device 102 shown in FIG. 1), can cause a first portion 410 of processing elements 402A-K to perform inference operations and cause a second group of components 520 having other computation components 508A-N to perform obfuscating operations concurrently with the performance of inference operations. In some implementations, the special hardware device is designed to include one or more computations components 508A-N for performing different types of obfuscating operations. The one or more computation components can include different types of units, such as logic units, multiplier-accumulator units, multiplexers, or other types of processing elements having different types and arrangements of computation units, e.g., GPU units.

Again, note the number of processing elements 502A-N, the number of computation units 506A-N in each processing element 502A-N, the number of computation units 506A-N in each portion, and the number of other computation components 508A-N are illustrative in FIG. 5. One should appreciate that these numbers and/or arrangements of computation units, processing elements, and computation components can vary based on different obfuscating requirements.

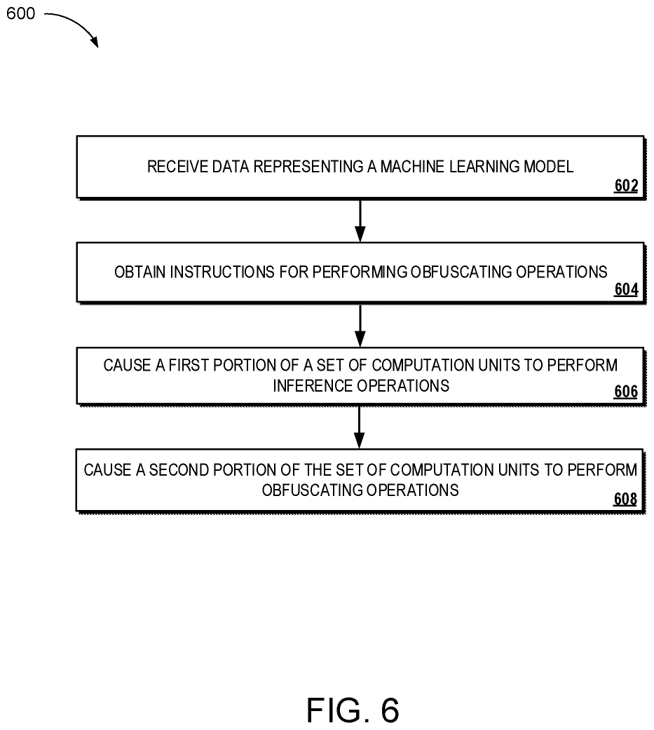

FIG. 6 is an example flow chart of process 600 for obfuscating inference operations of a machine learning model. For convenience, the process 600 is described as being performed by a system of one or more computers located in one or more locations. For example, the process 600 can be performed by a hardware device, e.g., the hardware device 102 shown in FIG. 1. The order of steps in the process 600 is illustrative only, and can be performed in different orders. In some implementations, the process 600 can include additional steps, fewer steps, or some of the steps can be divided into multiple steps.

The system receives data representing a machine learning model by a hardware device (610). The machine learning model can include multiple model parameters for inference operations. As described above, the machine learning model can include a neural network with multiple parameters defining the neural network. These parameters can include, for example, a number of network layers of the neural network, a number of nodes in each network layer of the neural network, a nodal operation for each node in each network layer of the neural network, and/or a weight value associated with each node in each network layer of the neural network. Different types of machine learning models include different types of parameters that define the models. The techniques described in this document can obfuscate any type of parameter that impacts the measurable characteristics of the machine learning model.

The system or the hardware device can include multiple processing elements and each processing element can include multiple computation units. The set of computation units in the hardware device can be configured to process respective inference operations of a neural network deployed on the hardware device.

The system obtains instructions for performing obfuscating operations (620). The obfuscating operations, when performed by the hardware device, are configured to obfuscate one or more measurable characteristics of the machine learning model. More specifically, the system can determine whether to perform inference operations of a neural network in a “secured mode.” The criteria for such a determination can be based on the nature or the application of the neural network (e.g., whether the neural network takes considerable time and resources to train, or whether the neural network is applied in security-sensitive applications), as described above.

In determining that the system would perform inference operations of the neural network in the “secured mode,” the system modifies the received instructions from a host or additions new instructions to the received instructions to obtain modified instructions that, when executed by the hardware device, cause the hardware device to perform inference operations and obfuscating operations concurrently. In some situations, the system assigns the obfuscating operations to one or more processing elements that also perform inference operations for one or more machine learning models; and reassigns a subset of the inference operations from the one or more processing elements to other processing elements of the hardware device. The details of generating modified instructions are described above.

The obfuscating operations can change at least one or more measurable characteristics of the neural network. The measurable characteristics can include at least one of a power profile, an electromagnetic profile, or a time profile. Once the measurable characteristics are changed, it would become more difficult to determine the parameters of the neural network based on the measurable characteristics. The obfuscating operations can include operations that are similar to the inference operations performed in a common time period, e.g., activation operations, tensor multiplications, and reductions. For example, the obfuscating operations can include an obfuscating nodal operation for a particular node in a network layer to be performed concurrently with a corresponding nodal operation for the particular node. The nodal operation can be a nodal addition or nodal multiplication. Alternatively, the obfuscating nodal operation can specify an activation function for the particular node, different from an actual activation function of the particular node performed concurrently with the obfuscating nodal operation.

In some implementations, the obfuscating operations can include operations irrelevant to and/or different from inference operations performed in a common time period. More details related to the obfuscating operations are described above.

The system causes a first portion of the set of computation units to perform the inference operations of the machine learning model (630). The first portion of computation units can be located within one or more processing elements in the hardware device.

The system causes a second portion of the set of computation units to perform the obfuscating operations concurrently with the first portion of the set of computation units performing the inference operations (640). The second portion of computation units can be located within one or more processing elements in the hardware device.

In some implementations, the system can determine, in a common processing element, a first portion of computation units in the common processing element to perform inference operations, and a second portion of computation units in the common processing element to perform corresponding obfuscating operations. One example of these implementations are shown and described in connection with FIG. 3. More generally, the instructions can specify that, at least a subset of the first portion of the set of computation units and a corresponding subset of the second portion of the set of computation units are located within a common processing element.

In some implementations, the system can determine that computation units for performing inference operations are in first processing elements, and computation units for performing corresponding obfuscating operations are located within second processing elements. The second processing elements are different from the first processing elements. One example of these implementations is shown and described in connection with FIG. 4. More generally, the instructions can specify that, at least a subset of the first portion of the set of computation units are located in a processing element, and at least a subset of the second portion of the set of computation units are located in a second processing element that is different from the first processing element.

Alternatively, the system can determine one or more other computation components for performing obfuscating operations. The one or more other computation components are not initially assigned to perform any inference operations. The one or more other computation components can be dedicatedly designed for the hardware device to perform obfuscating operations. The system can assign obfuscating operations to the other computation components, and maintain corresponding processing elements and computation units for performing the inference operations in a neural network.

This specification uses the term “configured to” in connection with systems, apparatus, and computer program components. That a system of one or more computers is configured to perform particular operations or actions means that the system has installed on it software, firmware, hardware, or a combination of them that in operation cause the system to perform those operations or actions. That one or more computer programs is configured to perform particular operations or actions means that the one or more programs include instructions that, when executed by data processing apparatus, cause the apparatus to perform those operations or actions. That special-purpose logic circuitry is configured to perform particular operations or actions means that the circuitry has electronic logic that performs those operations or actions.

The term “data processing apparatus” refers to data processing hardware and encompasses all kinds of apparatus, devices, and machines for processing data, including by way of example a programmable processor, a computer, or multiple processors or computers. The apparatus can also be or further include special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a smart phone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an Hypertext Markup Language (HTML) page, to a user device, e.g., for purposes of displaying data to and receiving user input from a user interacting with the user device, which acts as a client. Data generated at the user device, e.g., a result of the user interaction, can be received from the user device at the server.

In addition to the embodiments described above, the following embodiments are also innovative:

Embodiment 1 is a method, comprising: receiving, by a hardware device, data representing a machine learning model comprising a plurality of model parameters for inference operations, wherein the hardware device comprises a set of computation units arranged in one or more processing elements; obtaining instructions for performing obfuscating operations configured to obfuscate one or more measurable characteristics of the machine learning model when the machine learning model is executed by the one or more processing elements; causing a first portion of the set of computation units to perform the inference operations of the machine learning model; and causing a second portion of the set of computation units to perform the obfuscating operations concurrently with the first portion of the set of computation units performing the inference operations.

Embodiment 2 is the method of Embodiment 1, wherein the machine learning model is a neural network, wherein the obfuscating operations are configured to obscure at least one of a number of network layers of the neural network, a number of nodes in a network layer of the neural network, a nodal operation for a node in a network layer of the neural network, or a weight value associated with a node in a network layer of the neural network.

Embodiment 3 is the method of Embodiment 1 or 2, wherein the one or more measurable characteristics of the machine learning model comprises at least one of a power profile, an electromagnetic profile, or a time profile.

Embodiment 4 is the method of any one of Embodiments 1-3, wherein at least a subset of the first portion of the set of computation units and a corresponding subset of the second portion of the set of computation units are located within a common processing element.

Embodiment 5 is the method of any one of Embodiments 1-4, wherein at least a subset of the first portion of the set of computation units are located in a processing element, and at least a subset of the second portion of the set of computation units are located in a second processing element that is different from the first processing element.

Embodiment 6 is the method of any one of Embodiments 2-5, wherein the obfuscating operations include an obfuscating nodal operation for a particular node in a network layer to be performed concurrently with a corresponding nodal operation for the particular node.

Embodiment 7 is the method of Embodiment 6, wherein obfuscating nodal operation specifies an activation function for the particular node that is different from an actual activation function of the particular node.

Embodiment 8 is the method of any one of Embodiments 1-7, wherein causing the second portion of the set of computation units to perform the obfuscating operations concurrently with the first portion of the set of computation units performing the inference operations comprises assigning the obfuscating operations to a dedicated processing element that performs the obfuscating operations.

Embodiment 9 is the method of Embodiment 8, wherein the dedicated processing element includes one or more processing elements or computation units that are additionally incorporated into a hardware device and are configured to perform substantially only corresponding obfuscating operations.

Embodiment 10 is the method of any one of Embodiments 1-9, wherein causing the second portion of the set of computation units to perform the obfuscating operations concurrently with the first portion of the set of computation units performing the inference operations comprises: assigning the obfuscating operations to one or more processing elements that also perform inference operations for one or more machine learning models; and reassigning a subset of the inference operations from the one or more processing elements to other processing elements of the hardware device.

Embodiment 11 is the method of any one of Embodiments 2-10, wherein the neural network is configured to perform human face recognition tasks for unlocking devices.

Embodiment 12 is a system comprising one or more computers and one or more storage devices storing instructions that when executed by one or more computers cause the one or more computers to perform respective operations, the operations comprising the method of any one of Embodiments 1-11.

Embodiment 13 is one or more computer-readable storage media storing instructions that when executed by one or more computers cause the one or more computers to perform respective operations, the respective operations comprising the method of any one of Embodiments 1-11.

Embodiment 14 is a method, comprising: receiving, at a processor, a set of instructions to perform inference operations with a machine learning model, wherein the set of instructions includes at least one instruction to perform obfuscating operations concurrently with the inference operations; performing, at the processor, the inference operations with the machine learning model; and performing, at the processor, obfuscating operations concurrently with the inference operations.

Embodiment 15 is the method of Embodiment 14, wherein the obfuscating operations are configured to obfuscate one or more measurable characteristics of the machine learning model when the obfuscating operations are concurrently performed with the inference operations by the processor.

Embodiment 16 is the method of Embodiment 15, wherein the one or more measurable characteristics of the machine learning model comprises at least one of a power profile, an electromagnetic profile, or a time profile.

Embodiment 17 is the method of any one of Embodiments 14-16, wherein the machine learning model is a neural network, wherein the obfuscating operations are configured to obscure at least one of a number of network layers of the neural network, a number of nodes in a network layer of the neural network, a nodal operation for a node in a network layer of the neural network, or a weight value associated with a node in a network layer of the neural network.

Embodiment 18 is the method of Embodiment 17, wherein the neural network is configured to perform human face recognition tasks for unlocking devices.

Embodiment 19 is the method of Embodiment 17 or 18, wherein the obfuscating operations include an obfuscating nodal operation for a particular node in a network layer to be performed concurrently with a corresponding nodal operation for the particular node.

Embodiment 20 is the method of Embodiment 19, wherein obfuscating nodal operation specifies an activation function for the particular node that is different from an actual activation function of the particular node.

Embodiment 21 is the method of any one of Embodiments 14-20, wherein the processor is configured to assign a first portion of a set of computation units in the processor to perform the inference operations of the machine learning model, and assign a second portion of the set of computation units in the processor to perform the obfuscating operations concurrently with the first portion of the set of computation units performing the inference operations.

Embodiment 22 is the method of Embodiment 21, wherein at least a subset of the first portion of the set of computation units are located in a first processing element of the processor, and at least a subset of the second portion of the set of computation units are located in the same processing element or in a second processing element that is different from the first processing element.

Embodiment 23 is the method of Embodiment 21 or 22, wherein the second portion of the set of computation units comprise one or more computation units located in a dedicated processing element in the processor that performs the obfuscating operations.

Embodiment 24 is the method of Embodiment 23, wherein the dedicated processing element includes one or more processing elements or computation units that are additionally incorporated into the processor and are configured to perform substantially only corresponding obfuscating operations.

Embodiment 25 is the method of any one of Embodiments 14-24, wherein performing the obfuscating operations concurrently with the inference operations comprises: assigning the obfuscating operations to one or more processing elements in the processor that also perform inference operations for one or more machine learning models; and reassigning a subset of the inference operations from the one or more processing elements to other processing elements of the processor.

Embodiment 26 is a system comprising one or more computers and one or more storage devices storing instructions that when executed by one or more computers cause the one or more computers to perform respective operations, the operations comprising the method of any one of Embodiments 14-25.

Embodiment 27 is one or more computer-readable storage media storing instructions that when executed by one or more computers cause the one or more computers to perform respective operations, the respective operations comprising the method of any one of Embodiments 14-25.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments of the invention have been described. Other embodiments are within the scope of the following claims. For example, the steps recited in the claims, described in the specification, or depicted in the figures can be performed in a different order and still achieve desirable results. In some cases, multitasking and parallel processing may be advantageous.

What is claimed is:

1. A method, comprising:
receiving, by a hardware device, data representing a machine learning model comprising a plurality of model parameters for inference operations, wherein the hardware device comprises a set of computation units arranged in one or more processing elements;
obtaining instructions for performing obfuscating operations configured to obfuscate one or more measurable characteristics of the machine learning model when the machine learning model is executed by the one or more processing elements;
causing a first portion of the set of computation units to perform the inference operations of the machine learning model; and
causing a second portion of the set of computation units to perform the obfuscating operations concurrently with the first portion of the set of computation units performing the inference operations.

2. The method of claim 1, wherein the machine learning model is a neural network, wherein the obfuscating operations are configured to obscure at least one of a number of network layers of the neural network, a number of nodes in a network layer of the neural network, a nodal operation for a node in a network layer of the neural network, or a weight value associated with a node in a network layer of the neural network.

3. The method of claim 1, wherein the one or more measurable characteristics of the machine learning model comprises at least one of a power profile, an electromagnetic profile, or a time profile.

4. The method of claim 1, wherein at least a subset of the first portion of the set of computation units and a corresponding subset of the second portion of the set of computation units are located within a common processing element.

5. The method of claim 1, wherein at least a subset of the first portion of the set of computation units are located in a first processing element, and at least a subset of the second portion of the set of computation units are located in a second processing element that is different from the first processing element.

6. The method of claim 2, wherein the obfuscating operations include an obfuscating nodal operation for a particular node in a network layer to be performed concurrently with a corresponding nodal operation for the particular node.

7. The method of claim 6, wherein obfuscating nodal operation specifies an activation function for the particular node that is different from an actual activation function of the particular node.

8. The method of claim 1, wherein causing the second portion of the set of computation units to perform the obfuscating operations concurrently with the first portion of the set of computation units performing the inference operations comprises assigning the obfuscating operations to a dedicated processing element that performs the obfuscating operations.

9. The method of claim 8, wherein the dedicated processing element includes one or more processing elements or computation units that are additionally incorporated into a hardware device and are configured to perform substantially only corresponding obfuscating operations.

10. The method of claim 1, wherein causing the second portion of the set of computation units to perform the obfuscating operations concurrently with the first portion of the set of computation units performing the inference operations comprises:
assigning the obfuscating operations to one or more processing elements that also perform inference operations for one or more machine learning models; and
reassigning a subset of the inference operations from the one or more processing elements to other processing elements of the hardware device.

11. The method of claim 2, wherein the neural network is configured to perform human face recognition tasks for unlocking devices.

12. A system comprising a hardware device and one or more storage devices storing instructions that when executed by the hardware device cause the hardware device to perform operations, the operations comprising:
receiving, by the hardware device, data representing a machine learning model comprising a plurality of model parameters for inference operations, wherein the hardware device comprises a set of computation units arranged in one or more processing elements;
obtaining instructions for performing obfuscating operations configured to obfuscate one or more measurable characteristics of the machine learning model when the machine learning model is executed by the one or more processing elements;
causing a first portion of the set of computation units to perform the inference operations of the machine learning model; and
causing a second portion of the set of computation units to perform the obfuscating operations concurrently with the first portion of the set of computation units performing the inference operations.

13.-27. (canceled)

28. The system of claim 12, wherein the machine learning model is a neural network, wherein the obfuscating operations are configured to obscure at least one of a number of network layers of the neural network, a number of nodes in a network layer of the neural network, a nodal operation for a node in a network layer of the neural network, or a weight value associated with a node in a network layer of the neural network.

29. The system of claim 12, wherein the one or more measurable characteristics of the machine learning model comprises at least one of a power profile, an electromagnetic profile, or a time profile.

30. The system of claim 12, wherein at least a subset of the first portion of the set of computation units and a corresponding subset of the second portion of the set of computation units are located within a common processing element.

31. The system of claim 12, wherein at least a subset of the first portion of the set of computation units are located in a first processing element, and at least a subset of the second portion of the set of computation units are located in a second processing element that is different from the first processing element.

32. The system of claim 28, wherein the obfuscating operations include an obfuscating nodal operation for a particular node in a network layer to be performed concurrently with a corresponding nodal operation for the particular node.

33. The system of claim 32, wherein obfuscating nodal operation specifies an activation function for the particular node that is different from an actual activation function of the particular node.

34. The system of claim 12, wherein causing the second portion of the set of computation units to perform the obfuscating operations concurrently with the first portion of the set of computation units performing the inference operations comprises assigning the obfuscating operations to a dedicated processing element that performs the obfuscating operations.

35. One or more computer-readable storage media storing instructions that when executed by one or more computers cause the one or more computers to perform operations comprising:
receiving, by a hardware device, data representing a machine learning model comprising a plurality of model parameters for inference operations, wherein the hardware device comprises a set of computation units arranged in one or more processing elements;
obtaining instructions for performing obfuscating operations configured to obfuscate one or more measurable characteristics of the machine learning model when the machine learning model is executed by the one or more processing elements;
causing a first portion of the set of computation units to perform the inference operations of the machine learning model; and
causing a second portion of the set of computation units to perform the obfuscating operations concurrently with the first portion of the set of computation units performing the inference operations.
